(19) United States
(12) Patent Application Publication
(10) Pub. No.: US 2012/0124322 A1
(43) Pub. Date: May 17, 2012

(54) STORAGE DEVICE, NON-TRANSITORY COMPUTER READABLE MEDIUM AND METHOD OF CONTROLLING STORAGE DEVICE

(75) Inventor: Yoshiyuki TAKAGI, Nagoya-shi (JP)

(73) Assignee: Buffalo Inc., Nagoya-shi (JP)

(21) Appl. No.: 13/293,847

(22) Filed: Nov. 10, 2011

(30) Foreign Application Priority Data
Nov. 11, 2010 (JP) 2010-253041

(51) Int. Cl. G06F 12/06

(52) U.S. Cl. 711/173; 711/E12.084

(57) ABSTRACT

A storage device that stores at least one of video data and audio data comprising: a storage medium having a total storage area divided into multiple divided storage areas; a storage processing unit that selects a divided storage area other than a divided storage area that is most recently subjected to storage processing among the multiple divided storage areas, and stores, in a selected divided area, at least one of the video data and the audio data corresponding to a storage period unit; and a divided storage area control unit that performs initialization processing or defragmentation processing to the divided storage area which stores at least one of the video data and the audio data corresponding to the storage period unit.

### CROSS REFERENCE TO RELATED APPLICATIONS

This application is based upon and claims the benefit of priority from prior Japanese Patent Application No. 2010-253041, filed on Nov. 11, 2010; the entire content of which is incorporated herein by reference.

### BACKGROUND OF THE INVENTION

1. Field of the Invention

The present invention relates to a storage device which stores video data and audio data of, for example, television broadcasting, a non-transitory computer readable medium and a method of controlling the storage device.

2. Description of the Related Art

In a recording device which records program contents of television broadcasting, the total storage area of hard disk, which is a storage media, is divided into multiple partitions.

For example, in the technique described in JP-A-2000-99388, a storage area of hard disk device is divided into two partitions: files not to be rewritten in the future, i.e. fixed files, are stored in a first partition; and files to be rewritten in the future, i.e. cache files, are stored in a second partition. With this configuration, fragmentation of the files occurs mainly in the second partition and thus the total range in which fragmentation occurs is limited.

However, with the technique described in Patent Document 1, fragmentation in cache files in the second partition is not prevented. In a recording device, a cache file to be rewritten is video data and audio data. If such video data and audio data become fragmented, block noise, or other phenomena may be caused at the time of reproduction.

### SUMMARY OF THE INVENTION

A feature of the present invention is summarized as a storage device (recording device 10) that stores at least one of video data and audio data including: a storage medium (hard disk 104) having a total storage area (total storage area 200) divided into multiple divided storage areas (partitions 201-1 to 201-32); a storage processing unit (storage processing unit 112) that selects a divided storage area other than a divided storage area that is most recently subjected to storage processing among the multiple divided storage areas, and stores, in a selected divided area, at least one of the video data and the audio data corresponding to a storage period unit; and a divided storage area control unit (divided storage area control unit 114) that performs initialization processing or defragmentation processing to the divided storage area which stores at least one of the video data and the audio data corresponding to the storage period unit.

Such a storage device selects a divided storage area other than the divided storage area that is most recently subjected to storage processing among multiple divided storage areas, and stores, in the selected divided storage area, at least one of the video data and audio data corresponding to a storage period unit. The storage device performs initialization processing or defragmentation processing of the divided storage area which stores the video data and audio data corresponding to the storage period unit. The initialization processing or defragmentation processing to the divided storage area can prevent fragmentation at the time of storing new video data and audio data in that divided storage area.

A feature of the present invention is summarized as a storage device (recording device 10) that stores at least one of video data and audio data, including a storage medium (hard disk 104) having a total storage area (total storage area 200) divided into multiple divided storage areas (partitions 201-1 to 201-32); a storage processing unit (storage processing unit 112) that periodically selects at least one of the multiple divided storage areas and stores, in a selected divided area, at least one of the video data and the audio data corresponding to a storage period unit; and a divided storage area control unit (divided storage area control unit 114) that performs initialization processing or defragmentation processing to the divided storage area which stores at least one of the video data and the audio data corresponding to the storage period unit.

Such a storage device periodically selects at least one of multiple divided storage areas and stores, in the selected divided storage area, at least one of video data and audio data corresponding to a storage period unit. The storage device performs initialization processing or defragmentation processing of the divided storage area which stores the video data and audio data corresponding to the oldest storage period unit. The initialization processing or defragmentation processing to the divided storage area can prevent fragmentation at the time of storing new video data and audio data in that divided storage area.

A feature of the present invention is summarized as that the divided storage area control unit performs the initialization processing or the defragmentation processing to the divided storage area which stores at least one of the video data and the audio data corresponding to the oldest storage period unit.

It is considered that holding the video data and audio data corresponding to the oldest storage period unit is less necessary as compared with other video data and audio data. Therefore, fragmentation can be prevented while holding, as much as possible, necessary video data and audio data by performing the initialization processing or the defragmentation processing to the divided storage area which stores the video data and audio data corresponding to the oldest storage period unit.

A feature of the present invention is summarized as that the divided storage area control unit performs the initialization processing or the defragmentation processing to the divided storage area which stores at least one of the video data and the audio data corresponding to the oldest storage period unit, before the divided storage area which stores at least one of the video data and the audio data corresponding to the oldest storage period unit is used for storing new video data or audio data.

A feature of the present invention is summarized as that, if the number of the divided storage areas which have undergone the initialization processing or the defragmentation processing is one, the divided storage area control unit performs the initialization processing or the defragmentation processing to the divided storage area which stores at least one of the video data and the audio data corresponding to the oldest storage period unit.

A feature of the present invention is summarized as that the total storage area has the multiple divided storage areas whose number is larger than the number of the storage period units forming a predetermined storage period by one.

A feature of the present invention is summarized as the storage processing unit deletes at least one of the video data and the audio data corresponding to the oldest storage period unit; and after at least one of the video data and the audio data corresponding to the oldest storage period unit is deleted, the divided storage area control unit performs the initialization processing to the divided storage area which stores at least one of the video data and the audio data corresponding to the oldest storage period unit.

A feature of the present invention is summarized as that the storage processing unit stores, in an external storage medium, at least one of the video data and the audio data corresponding to the oldest storage period unit; and after at least one of the video data and the audio data corresponding to the oldest storage period unit is stored in the external storing medium, the divided storage area control unit performs the initialization processing to the divided storage area which stores at least one of the video data and the audio data corresponding to the oldest storage period unit.

A feature of the present invention is summarized as a non-transitory computer readable medium including a computer program instruction cause a computer to store at least one of video data and audio data in a storage medium having a total storage area divided into multiple divided storage areas, the computer program instructions cause the computer to perform a method comprising the steps of: selecting a divided storage area other than a divided storage area that is most recently subjected to storage processing among the multiple divided storage areas, and storing, in a selected divided storage area, at least one of the video data and the audio data corresponding to a storage period unit; and performing initialization processing or defragmentation processing to the divided storage area which stores at least one of the video data and the audio data corresponding to the storage period unit.

A feature of the present invention is summarized as a non-transitory computer readable medium including a computer program instruction cause a computer to store at least one of video data and audio data in a storage medium having a total storage area divided into multiple divided storage areas, the computer program instructions cause the computer to perform a method comprising the steps of: periodically selecting at least one of the multiple divided storage areas and stores, in a selected divided area, at least one of the video data and the audio data corresponding to a storage period unit; and performing initialization processing or defragmentation processing to the divided storage area which stores at least one of the video data and the audio data corresponding to the storage period unit.

A feature of the present invention is summarized as a method of controlling a storage device which includes a storage medium having a total storage area divided into multiple divided storage areas and stores at least one of video data and audio data, comprising the steps of: selecting a divided storage area other than a divided storage area that is most recently subjected to storage processing among the multiple divided storage areas, and stores, in a selected divided storage area, at least one of the video data and the audio data corresponding to a storage period unit; and performing initialization processing or defragmentation processing to the divided storage area which stores at least one of the video data and the audio data corresponding to the storage period unit.

A feature of the present invention is summarized as a method of controlling a storage device which includes a storage medium having a total storage area divided into multiple divided storage areas and stores at least one of video data and audio data, comprising the steps of: periodically selecting at least one of the multiple divided storage areas and stores, in a selected divided area at least one of the video data and the audio data corresponding to a storage period unit; and performing initialization processing or defragmentation processing to the divided storage area which stores at least one of the video data and the audio data corresponding to the storage period unit.

### BRIEF DESCRIPTION OF THE DRAWINGS

FIG. 1 illustrates a schematic configuration of a storage system according to the present embodiment.

FIG. 2 illustrates, in a block diagram, a detailed configuration of a recording device according to the present embodiment.

FIGS. 3A to 3C illustrate an example of a storage area of hard disk.

FIGS. 4A to 4C illustrate an example of a management table of a divided storage area.

FIG. 5 is a flowchart which illustrates a first operation of the recording device according to the present embodiment.

FIG. 6 is a flowchart which illustrates a second operation of the recording device according to the present embodiment.

### DETAILED DESCRIPTION OF THE EMBODIMENTS

### (1) Schematic Configuration of Storage System

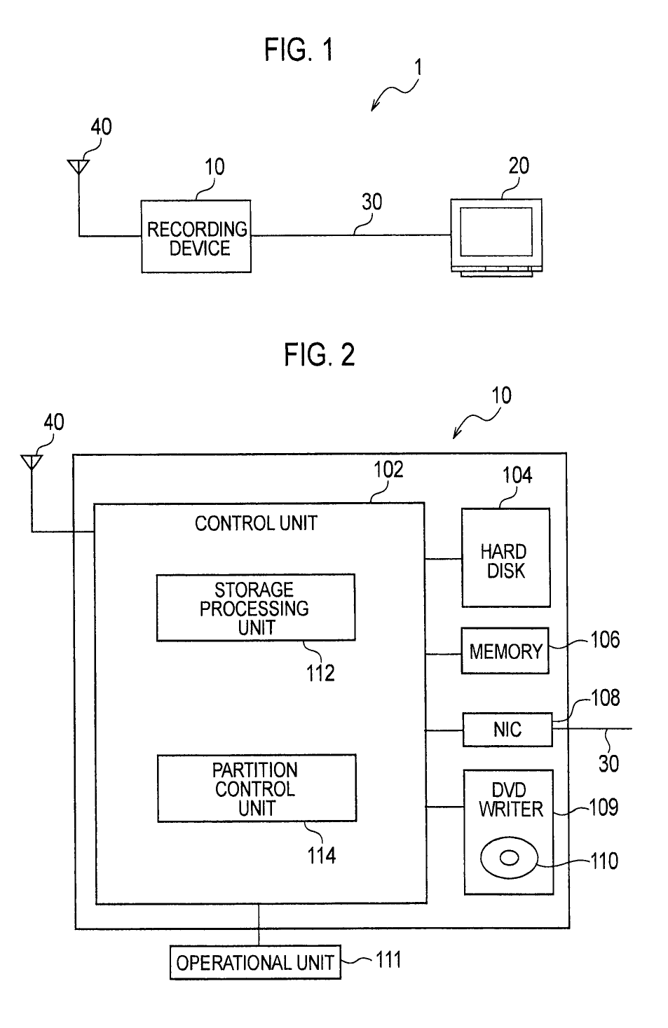

A schematic configuration of a storage system according to the present embodiment will be described with reference to FIG. 1. FIG. 1 illustrates a schematic configuration of a storage system 1 according to the present embodiment. As illustrated in FIG. 1, the storage system 1 includes a recording device 10 and a digital broadcasting receiving system 20. The storage system 1 is installed in a house.

An antenna 40 is connected to the recording device 10 and the recording device 10 receives digital broadcasting signals via the antenna 40. The recording device 10 is connected to the digital broadcasting receiving system 20 via a communication line 30 which is a local area network (LAN) cable.

### (2) Configuration of Recording Device

FIG. 2 illustrates, in a block diagram, a detailed configuration of the recording device 10.

The recording device 10 illustrated in FIG. 2 is a device capable of storing video data and audio data of 31 days acquired from the digital broadcasting signals. The recording device 10 includes a control unit 102, hard disk 104, memory 106, a network interface card (NIC) 108, a digital versatile disc (DVD) writer 109 and an operational unit 111.

The control unit 102 is constituted by, for example, a CPU and controls various functions of the recording device 10. The control unit 102 includes a storage processing unit 112 and a partition control unit 114. The hard disk 104 stores video data and audio data acquired from the digital broadcasting signals. The memory 106 is, for example, DDR-SRAM and stores information necessary to implement various functions of the recording device 10. The NIC 108 is connected to the communication line 30. The NIC 108 is in accordance with some standards, such as IEEE802.11b, IEEE802.11g and IEEE802.11n, and transmits the video data and audio data stored in the hard disk 104 to the digital broadcasting receiving system 20 via the communication line 30. The DVD writer 109 writes the video data and audio data acquired from the control unit 102 in the DVD 110 which is inserted therein. The operational unit 111 receives various manipulations by a user and outputs manipulation signals corresponding to the manipulations to the control unit 102.

The control unit 102 has a function as a tuner. The digital broadcasting signals received via the antenna 40 are input in the control unit 102. In the present embodiment, the input digital broadcasting signals are digital broadcasting signals of either of the ground digital broadcasting, the BS digital broadcasting or the CS digital broadcasting. When the digital broadcasting signals are input, the control unit 102 demodulates the digital broadcasting signals and acquires video signals and audio signals. The control unit 102 decodes the video signals and the audio signals and acquires video data and audio data.

The storage processing unit 112 in the control unit 102 stores the video data and the audio data in the hard disk 104 and updates a partition management table stored in the memory 106.

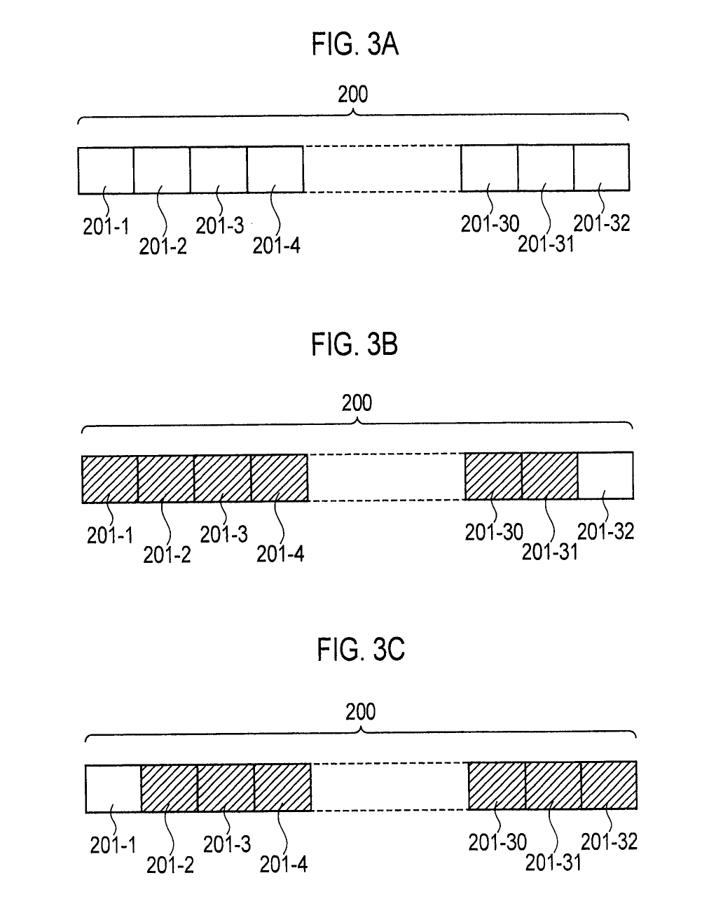

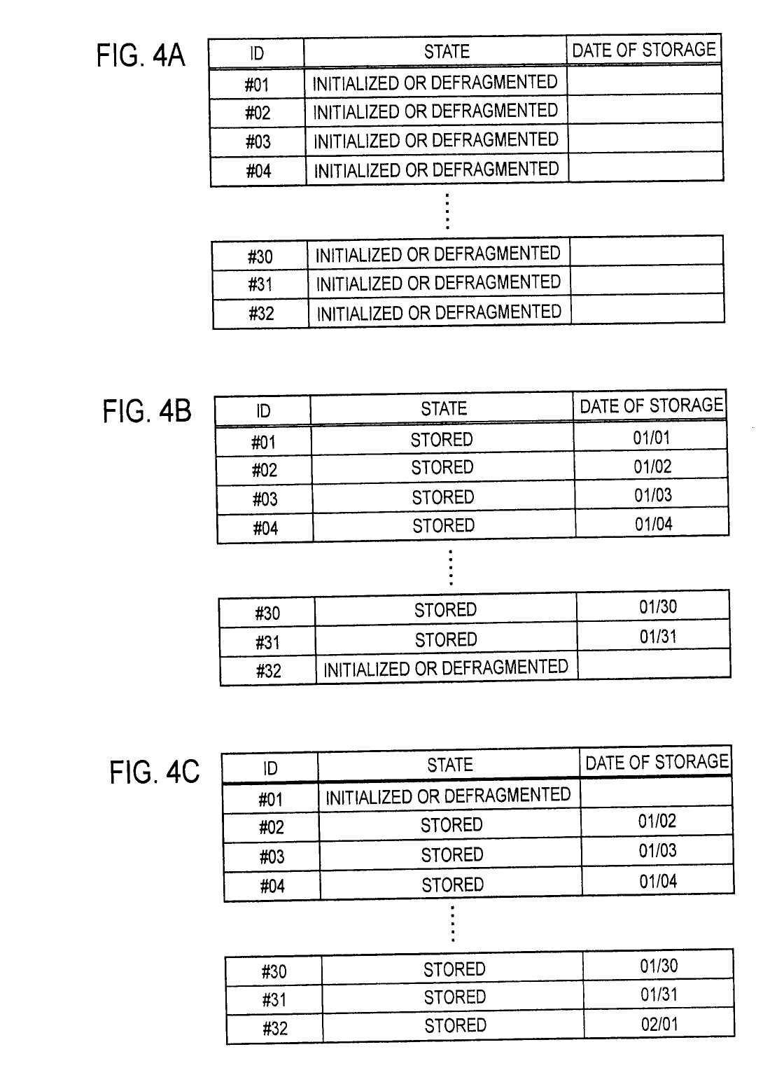

FIGS. 3A to 3C illustrate an example of a storage area of the hard disk 104. FIGS. 4A to 4C illustrate an example of the partition management table.

As illustrated in FIGS. 3A to 3C, the total storage area 200 of the hard disk 104 is divided into 32 sections, i.e., 1 is added to 31 that is the number of days capable of storing data. Thus, partitions 201-1 to 201-32 are created. The partitions 201-1 to 201-32 each correspond to one day, which is a storage period unit. The partitions 201-1 to 201-32 in each of which video data and audio data of one day can be stored are identified by IDs (#01 to #32).

As illustrated in FIGS. 4A to 4C, the partition management table includes, for each partition, the ID of that partition, the state of the partition, and the date on which video data and audio data are stored if any video data and audio data are stored.

In an initial state, as illustrated in FIG. 3A, all the partitions 201-1 to 201-32 have undergone initialization processing or defragmentation processing and thus are capable of storing new video data and audio data. The partition management table in this case is illustrated in FIG. 4A.

When the storage time of the day (for example, the time at which recording is programmed) comes in each day, the storage processing unit 112 selects the partition which has undergone the initialization processing or defragmentation processing among the partitions 201-1 to 201-32.

If multiple partitions which have undergone the initialization processing or defragmentation processing exist, the storage processing unit 112 selects either of them. In the present embodiment, the storage processing unit 112 selects the next partition of the partition which stores the latest video data and audio data among the video data and the audio data with dates of the past.

The storage processing unit 112 stores the video data and the audio data of that day in the selected partition. The storage processing unit 112 updates the state of record in the partition management table corresponding to the selected partition to “stored” and sets the date of storage.

If the number of partitions which have undergone the initialization processing or defragmentation processing is one among the partitions 201-1 to 201-32, the storage processing unit 112 stores the video data and the audio data of that day in the selected partition and, at the same time, the partition control unit 114 selects the partition which stores the video data and the audio data corresponding to the oldest date with reference to the partition management table and performs the initialization processing or the defragmentation processing to the selected partition. The partition control unit 114 updates the state of record in the partition management table corresponding to the selected partition to “initialized or defragmented” and deletes the date of storage.

Suppose that, for example, as illustrated in FIG. 3B, video data and audio data are stored in the partitions 201-1 to 201-31 and that the partition 201-32 has undergone the initialization processing or defragmentation processing. The partition management table in this case is illustrated in FIG. 4B.

In the case of FIG. 3B, the partition which has undergone the initialization processing or defragmentation processing is only the partition 201-32. In this case, the storage processing unit 112 stores the video data and the audio data in the partition 201-32. The partition control unit 114 selects, with reference to the partition management table illustrated in FIG. 4B, the partition 201-1 of ID#01 which stores the video data and the audio data as of January 1st which are the video data and the audio data corresponding to the oldest date. The partition control unit 114 performs initialization processing or defragmentation processing to the selected partition 201-1. As a result, as illustrated in FIG. 3C, the video data and the audio data are stored in the partitions 201-2 to 201-32, and the partition 201-1 is initialized or defragmented. The partition management table in this case is illustrated in FIG. 4C.

If the partition which stores the video data and the audio data corresponding to the oldest date is subjected to the initialization processing, the storage processing unit 112 deletes, before the initialization processing, the video data and the audio data corresponding to the oldest date from that partition which stores the video data and the audio data corresponding to the oldest date. The partition control unit 114 performs initialization processing after the deletion.

The storage processing unit 112 may read the video data and the audio data corresponding to the oldest date from the partition which stores the video data and the audio data corresponding to the oldest date and may output the read data to the DVD writer 109. In this case, the DVD writer 109 writes the input video data and audio data corresponding to the oldest date in the DVD 110. The partition control unit 114 performs the initialization processing after the writing in the DVD 110.

### (3) Operation of Recording Device

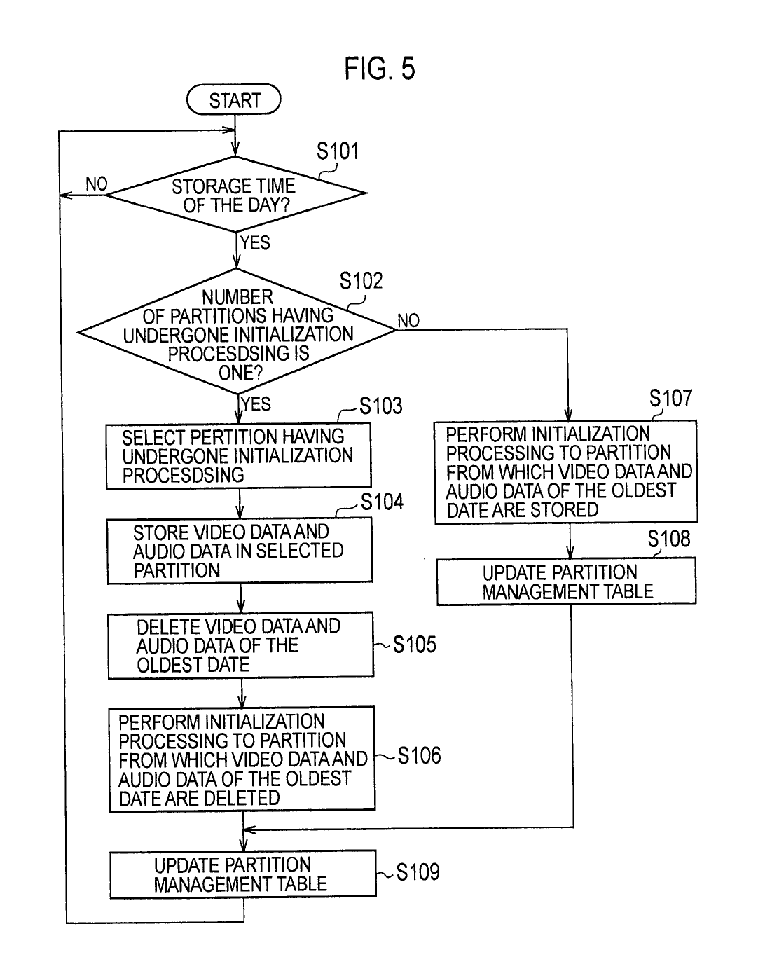

FIG. 5 is a flowchart which illustrates a first operation of the recording device 10.

In step S101, the storage processing unit 112 determines whether the storage time of that day came. When the storage time of that day comes, the storage processing unit 112 determines, in step S102, whether the number of partitions which have undergone the initialization processing is one.

If the number of partitions which have undergone the initialization processing is one, the storage processing unit 112 selects that partition in step S103. In step S104, the storage processing unit 112 stores the video data and the audio data of that day in the partition selected in step S103.

In step S105, the partition control unit 114 deletes the video data and the audio data of the oldest date among the video data and the audio data stored in the hard disk 104.

In step S106, the partition control unit 114 performs initialization processing to the partition from which the video data and the audio data of the oldest date have been deleted.

In step S109, the storage processing unit 112 and the partition control unit 114 update the partition management table after step S106.

If, on the other hand, it is determined in step S102 that the number of partitions which have undergone the initialization processing is not one, the storage processing unit 112 selects, in step S107, the next partition of the partition which stores the latest video data and audio data among the video data and the audio data with dates of the past.

In step S108, the storage processing unit 112 stores the video data and the audio data of that day in the partition selected in step S107.

In step S109, the storage processing unit 112 updates the partition management table after step S108.

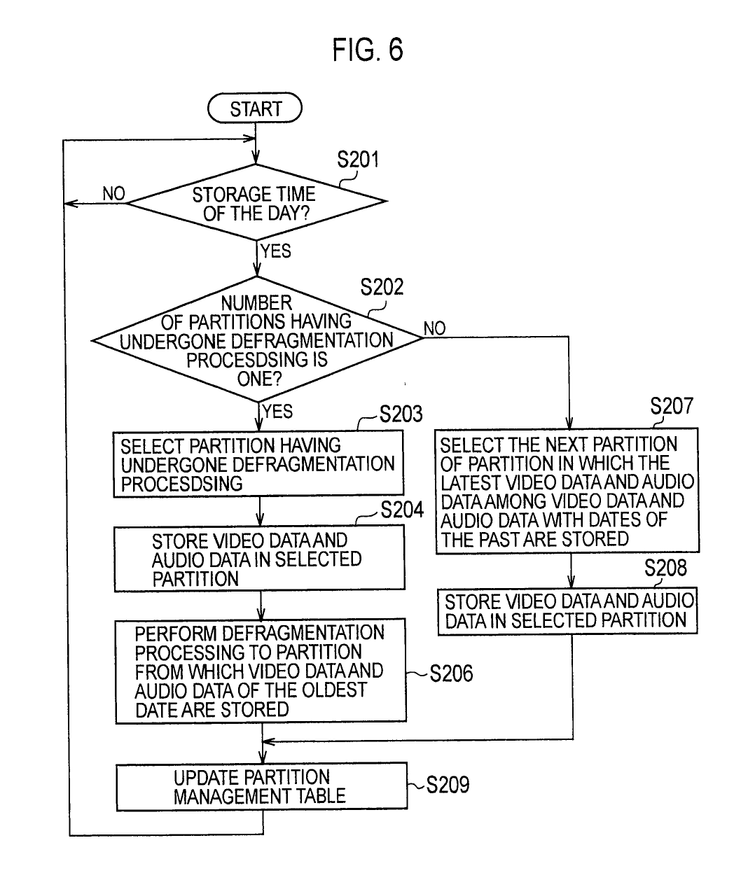

FIG. 6 is a flowchart which illustrates a second operation of the recording device 10.

In step S201, the storage processing unit 112 determines whether the storage time of that day came. When the storage time of that day comes, the storage processing unit 112 determines, in step S202, whether the number of partitions which have undergone the defragmentation processing is one.

If the number of partitions which have undergone the defragmentation processing is one, the storage processing unit 112 selects that partition in step S203. In step S204, the storage processing unit 112 stores the video data and the audio data of that day in the partition selected in step S203.

In step S206, the partition control unit 114 performs defragmentation processing to the partition which stores the video data and the audio data of the oldest date among the video data and the audio data stored in the hard disk 104.

In step S209, the storage processing unit 112 and the partition control unit 114 update the partition management table after step S206.

If, on the other hand, it is determined in step S202 that the number of partitions which have undergone the defragmentation processing is not one, the storage processing unit 112 selects, in step S207, the next partition of the partition which stores the latest video data and audio data among the video data and the audio data with dates of the past.

In step S208, the storage processing unit 112 stores the video data and the audio data of that day in the partition selected in step S207.

In step S209, the storage processing unit 112 updates the partition management table after step S208.

### (4) Operation and Effect

In the storage system 1 of the present embodiment, the total storage area 200 of the hard disk 104 is divided into 32 sections in the recording device 10 and the partition 201-1 to 201-32 are created. The storage processing unit 112 periodically selects the partition 201-1 to 201-32 and stores video data and audio data in the selected partition. If the number of the partitions which have undergone the initialization processing or defragmentation processing is one, the partition control unit 114 performs initialization processing or defragmentation processing to the partition which stores the video data and the audio data corresponding to the oldest date.

The initialization processing or defragmentation processing performed sequentially to multiple partitions can prevent fragmentation at the time of storing new video data and audio data in that partition. In addition, since the initialization processing or the defragmentation processing to one partition is performed again before that partition is used for the storage of the new video data and audio data, fragmentation can be prevented with increased reliability.

Since it is considered that holding the video data and the audio data corresponding to the oldest date is less necessary as compared with other video data and audio data, fragmentation can be prevented while holding, as much as possible, necessary video data and audio data by performing the initialization processing or the defragmentation processing to the partition which stores the video data and the audio data corresponding to the oldest date.

### (5) Other Embodiments

Although the present invention has been described with reference to an embodiment, it is not to be contemplated that the discussion and drawing which partially constitute the present disclosure is not limited thereto. Various alternative embodiments, examples and operation technology will be apparent to a person skilled in the art from the present disclosure.

In the embodiment described above, when the storage time of that day comes in each day, the storage processing unit 112 selects the partition which has undergone the initialization processing or defragmentation processing among the partitions 201-1 to 201-32. However, the storage processing unit 112 may select a partition which stores video data and audio data in response to user instructions.

In particular, when the user performs a manipulation to select a partition via the operational unit 111, the storage processing unit 112 receives manipulation signals in response to the user manipulation from the operational unit 111. Then, the storage processing unit 112 selects any one of the partitions among the partitions 201-1 to 201-32 in response to the manipulation signals. Preferably, the partition selected here is one other than the partition that is most recently subjected to storage processing. It is therefore preferable that, if the manipulation signals indicate that the partition that is most recently subjected to storage processing is to be selected, the storage processing unit 112 does not select the partition corresponding to those manipulation signals.

Similarly, the storage processing unit 112 stores the video data and the audio data of that day in the selected partition. The storage processing unit 112 updates the state of record in the partition management table corresponding to the selected partition to “stored” and sets the date of storage.

The storage period unit is one day in the embodiment described above; but the storage period unit may be one hour, one week or other periods. In these cases, the total storage area 200 has the multiple partitions whose number is larger than the number of the storage period units forming the predetermined storage period by one.

Although the DVD 110 is used as an external storage medium in the embodiment described above, other external storage media, such as a Blu-ray disc and a SD memory card, may also be used.

Although the recording device 10 and each digital broadcasting receiving system is connected via a LAN cable in the embodiment described above, the present invention can be applied similarly if other communication lines are used.

Although the storage which stores the video data and the audio data acquired from the digital broadcasting signals has been described in the embodiment described above, the present invention can be applied similarly to the storage of other video data and audio data, such as video data and audio data from, for example, the Internet distributed through streaming and video data and audio data acquired from analog broadcasting signals.

Although not described in the above embodiments, a computer program instruction causes a computer to perform the steps shown in FIG. 5 or FIG. 6. The computer program instruction may be included in the computer readable medium. The computer program instructions may be installed to the computer by using the computer readable medium. the computer readable medium including the computer program instruction may be a non-transitory recording medium. Although not limited, the non-transitory recording medium may be a recording medium such as CD-ROM or DVD-ROM, for example.

It is therefore to be understood that the present invention includes various embodiments which are not mentioned herein. Accordingly, the present invention should be limited only by the matters to define the invention in the scope of claims regarded as appropriate in accordance with the present disclosure.

What is claimed is:

1. A storage device that stores at least one of video data and audio data comprising:
a storage medium having a total storage area divided into multiple divided storage areas;
a storage processing unit that selects a divided storage area other than a divided storage area that is most recently subjected to storage processing among the multiple divided storage areas, and stores, in a selected divided area, at least one of the video data and the audio data corresponding to a storage period unit; and
a divided storage area control unit that performs initialization processing or defragmentation processing to the divided storage area which stores at least one of the video data and the audio data corresponding to the storage period unit.

2. A storage device that stores at least one of video data and audio data, comprising:
a storage medium having a total storage area divided into multiple divided storage areas;
a storage processing unit that periodically selects at least one of the multiple divided storage areas and stores, in a selected divided area, at least one of the video data and the audio data corresponding to a storage period unit; and
a divided storage area control unit that performs initialization processing or defragmentation processing to the divided storage area which stores at least one of the video data and the audio data corresponding to the storage period unit.

3. The storage device according to claim 1 or 2, wherein the divided storage area control unit performs the initialization processing or the defragmentation processing to the divided storage area which stores at least one of the video data and the audio data corresponding to the oldest storage period unit.

4. The storage device according to claim 3, wherein the divided storage area control unit performs the initialization processing or the defragmentation processing to the divided storage area which stores at least one of the video data and the audio data corresponding to the oldest storage period unit, before the divided storage area which stores at least one of the video data and the audio data corresponding to the oldest storage period unit is used for storing new video data or audio data.

5. The storage device according to claim 3, wherein, if the number of the divided storage areas which have undergone the initialization processing or the defragmentation processing is one, the divided storage area control unit performs the initialization processing or the defragmentation processing to the divided storage area which stores at least one of the video data and the audio data corresponding to the oldest storage period unit.

6. The storage device according to claim 1 or 2, wherein the total storage area has the multiple divided storage areas whose number is larger than the number of the storage period units forming a predetermined storage period by one.

7. The storage device according to claim 3, wherein:
the storage processing unit deletes at least one of the video data and the audio data corresponding to the oldest storage period unit; and
after at least one of the video data and the audio data corresponding to the oldest storage period unit is deleted, the divided storage area control unit performs the initialization processing to the divided storage area which stores at least one of the video data and the audio data corresponding to the oldest storage period unit.

8. The storage device according to claim 3, wherein:
the storage processing unit stores, in an external storage medium, at least one of the video data and the audio data corresponding to the oldest storage period unit; and
after at least one of the video data and the audio data corresponding to the oldest storage period unit is stored in the external storing medium, the divided storage area control unit performs the initialization processing to the divided storage area which stores at least one of the video data and the audio data corresponding to the oldest storage period unit.

9. A non-transitory computer readable medium including a computer program instruction cause a computer to store at least one of video data and audio data in a storage medium having a total storage area divided into multiple divided storage areas, the computer program instructions cause the computer to perform a method comprising the steps of:
selecting a divided storage area other than a divided storage area that is most recently subjected to storage processing among the multiple divided storage areas, and storing, in a selected divided storage area, at least one of the video data and the audio data corresponding to a storage period unit; and
performing initialization processing or defragmentation processing to the divided storage area which stores at least one of the video data and the audio data corresponding to the storage period unit.

10. A non-transitory computer readable medium a computer program instruction cause a computer to store at least one of video data and audio data in a storage medium having a total storage area divided into multiple divided storage areas, the computer program instructions cause the computer to perform a method comprising the steps of:
periodically selecting at least one of the multiple divided storage areas and stores, in a selected divided area, at least one of the video data and the audio data corresponding to a storage period unit; and
performing initialization processing or defragmentation processing to the divided storage area which stores at least one of the video data and the audio data corresponding to the storage period unit.

11. A method of controlling a storage device which includes a storage medium having a total storage area divided into multiple divided storage areas and stores at least one of video data and audio data, comprising the steps of:
selecting a divided storage area other than a divided storage area that is most recently subjected to storage processing among the multiple divided storage areas, and stores, in a selected divided storage area, at least one of the video data and the audio data corresponding to a storage period unit; and
performing initialization processing or defragmentation processing to the divided storage area which stores at least one of the video data and the audio data corresponding to the storage period unit.

12. A method of controlling a storage device which includes a storage medium having a total storage area divided into multiple divided storage areas and stores at least one of video data and audio data, comprising the steps of:
periodically selecting at least one of the multiple divided storage areas and stores, in a selected divided area at least one of the video data and the audio data corresponding to a storage period unit; and
performing initialization processing or defragmentation processing to the divided storage area which stores at least one of the video data and the audio data corresponding to the storage period unit.
